(19) United States
(12) Patent Application Publication
(10) Pub. No.: US 2024/0352939 A1
(43) Pub. Date: Oct. 24, 2024

(54) METHOD FOR QUANTITATIVELY DETERMINING CURRENT OPERATING-STATE-DEPENDENT VARIABLES, MORE PARTICULARLY THE CURRENT CONVEYED VOLUMETRIC FLOW RATE, OR A FAN, AND FAN FOR APPLICATION OF THE METHOD

(71) Applicant: ZIEHL-ABEGG SE, Künzelsau (DE)

(72) Inventors: Frieder LOERCHER, Braunsbach (DE); Alexander HEROLD, Hardthausen (DE)

(21) Appl. No.: 18/685,800

(22) PCT Filed: Aug. 11, 2022
(86) PCT No.: PCT/DE2022/200180

§ 371 Date: Feb. 22, 2024

(30) Foreign Application Priority Data
Sep. 3, 2021 (DE) 10 2021 209 753.7

(51) Int. Cl. F04D 27/00

(52) U.S. Cl. CPC F04D 27/004; F05D 2270/3015; F05D 2270/304

(57) ABSTRACT

The present disclosure relates to a method for quantitatively determining the current conveyed volumetric flow rate or another operating-point-dependent variable of a fan which comprises a motor-driven impeller, which method uses a motor-internal variable and a motor-external variable, from which the conveyed volumetric flow rate or another operating-point-dependent variable is directly or indirectly calculated or determined by means of an algorithm.

### CROSS REFERENCE

This application is a national stage entry application under 35 U.S.C. 371 of PCT Patent Application No. PCT/DE2022/200180, filed on 11 Aug. 2022, which claims priority to German Patent Application No. 10 2021 209 753.7, filed on 3 Sep. 2021 the entire contents of each of which are incorporated herein by reference.

### FIELD

The present disclosure relates to a method for quantitatively determining current operating-state-dependent variables, in particular the current conveying volume flow, of a fan, wherein the fan comprises at least one motor-driven impeller. The method furthermore relates to a fan for applying the method.

The fan is not specified in any more detail. Therefore, the fan involved here may basically be a fan of any design, specifically radial, diagonal or axial fans.

### BACKGROUND

Particularly for the purpose of controlling a fan, there is a need to continuously determine the volume flow during operation of the fan. Other operating-state-dependent variables, such as the current pressure increase, for example, can also be determined based on the knowledge of the current conveying volume flow or else directly. In addition to controlling the fan speed at a specified volume flow, the knowledge of the current conveying volume flow and/or other operating-state-dependent variables can be used in many ways, for example when monitoring the fan power or the state of a ventilation system.

In terms of the fan, when the pressure increase is known, it is possible to monitor the pressure reserve of a fan which is susceptible to stalling, for example. It is possible to identify whether a fan is operating in a permissible operating range, for example to also identify whether a so-called drum motor is operating at pressures which are too low.

Examples of other useful operating-state-dependent variables may be: current conveying mass flow, current noise emissions of a fan, the current torque of a fan, the current efficiency of a fan or a current thrust generated by the fan.

Furthermore, an operating-state-dependent variable may also be a variable combined from variables which have already been specified, for example a function of pressure increase and conveying volume flow. Volume flow/pressure characteristic curves can thus be mapped in this way. It is known from practice to determine the current conveying volume flow or conveying mass flow rate in forward-curved radial fans by means of the shaft torque. Otherwise, the volume flow is determined by way of measuring the differential pressure or by means of vane anemometers. In this respect, reference is made by way of example to WO 2018/036802 A1. However, the processes for measuring and identifying the volume flow of air known from practice are inaccurate and complex to implement.

Inaccuracies arise particularly when determining the volume flow by means of a vane anemometer arranged close to the fan impeller on the inflow side or on the outflow side, especially since the speed of the vane anemometer in addition to the conveying volume flow may be influenced by an operating-state-dependent, inhomogeneous and/or swirl-affected flow pattern over the throughflow cross section at the anemometer wheel.

### SUMMARY

The present disclosure is based, in part, on the object of specifying a method for quantitatively determining the current conveying volume flow or another current operating-state-dependent variable of a fan during operation with high a degree of accuracy and comparatively low construction/technical outlay which also differs from competitive methods. A fan for using the method is also to be specified.

The aforementioned object is achieved in relation to the method, in an embodiment, by way of the features of claim 1 and in relation to the fan, in an embodiment, by way of the features of coordinate claim 11. Accordingly, a motor-internal variable and a motor-external variable are determined, from which the conveying volume flow and/or other current operating-state-dependent variables is/are directly or indirectly calculated or determined by means of an algorithm.

The present disclosure has identified that a quantitative determination of the current conveying volume flow or another current operating-state-dependent variable using motor-internal and motor-external variables is possible and with a high degree of accuracy and with comparatively low technical outlay. The combination of at least one motor-internal variable with at least one motor-external variable, which are both easy to detect, is essential. By using the two-different-variables, the dependency of the operating state on purely motor-external signals can be eliminated.

The motor-internal variable used may be an electric current, for example a winding current, or a motor current or else also a motor voltage. An electrical power can also be used. These variables relate to the situation in the motor and/or in the control system thereof. As an alternative or in addition, the motor speed can also be used as the motor-internal variable.

The motor-external variable used may be the measured value or the signal of a sensor which is arranged in the immediate vicinity of the fan or the impeller. The sensor may be a volume flow measuring wheel. The relevant variable would then be the measuring wheel speed.

The volume flow measuring wheel is, in an embodiment, advantageously mounted on an inflow-side or on an outflow-side structure so as to be able to rotate. The structure may be an inflow grille or any housing part. In this respect, there are no additional structural measures to take.

As an alternative or in addition, the sensor is a thermal sensor, for example a hot-wire anemometer, which reacts sensitively to flow velocities.

It is also conceivable that the sensor is a differential pressure sensor which detects a pressure difference between two specific points in the flow field of the fan.

The algorithm used for the calculation may, in an embodiment, advantageously be implemented in the motor control system or in an external evaluation unit. Said algorithm usually includes a processor and a memory. The sensor signals can be transmitted to the processor via wire or contactlessly, via radio or similar.

The fan or the motor of the fan, in an embodiment, advantageously has an interface which is used to transmit the determined current conveying volume flow and/or another current operating-state-dependent variable to a superordinate system. In this respect, it is also advantageous if a signal for a setpoint volume flow, a setpoint mass flow or a setpoint value for another operating-state-dependent variable is transferred to the motor and/or to the evaluation unit, said signal being used to control the motor speed in such a way that the conveying volume flow or conveying mass flow or the operating-state-dependent variable determined using the sensor signal or the sensor signals corresponds as accurately as possible to the setpoint volume flow or setpoint mass flow or to the corresponding setpoint value.

The fan according to the present disclosure is used in particular to control the current conveying volume flow or another operating-state-dependent variable according to the preceding statements.

There are, then, various possibilities of advantageously configuring and developing the teaching of the present disclosure. In this respect, reference should be made firstly to the claims subordinate to claim 1 and secondly to the following explanation of exemplary embodiments of the method according to the present disclosure with reference to the drawings. Generally preferred configurations and developments of the teaching are also explained in conjunction with the explanation of the exemplary embodiments of the disclosure with reference to the drawings.

### BRIEF DESCRIPTION OF THE SEVERAL VIEWS OF THE DRAWINGS

FIG. 1 shows one embodiment of a fan as seen in a perspective view and in section at a plane through the axis of rotation of the impeller, wherein the current conveying volume flow or the current operating-state-dependent variable is determined using a vane anemometer,

FIG. 2 shows a graph in which characteristic curves of a pressure increase Δp in each case as a function of a conveying volume flow Oᵥ are illustrated for a fan at a particular conveying medium density for four different constant anemometer speeds and additionally for two constant motor speeds, and

FIG. 3 a graph in which characteristic curves of a pressure increase Δp in each case as a function of a conveying volume flow Qᵥ are illustrated for a fan at a particular conveying medium density for four different constant anemometer speeds and additionally for five constant motor speeds.

### DETAILED DESCRIPTION OF THE DISCLOSURE

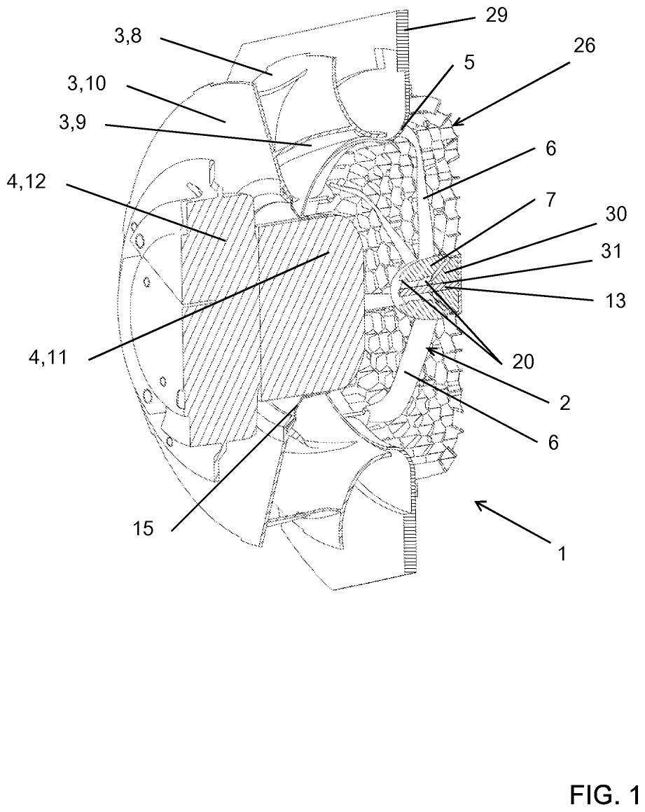

FIG. 1 shows one embodiment of a fan 1 as seen in a perspective view and in section at a plane through the axis of rotation of the impeller 3, wherein the current conveying volume flow or another operating-point-dependent variable is precisely determined by means of a volume flow measuring wheel 2. The volume flow measuring wheel 2 is essentially made of a hub 7 and blades 6 secured thereto. The illustration clearly shows the volume flow measuring wheel 2 and the mounting thereof on an inflow-side structure, in this case an inflow grille 26. An axle 13 for mounting the volume flow measuring wheel 2 is mounted on the central region 30 of the inflow grille 26 via a receiving region 31.

The volume flow measuring wheel 2 is mounted on the axis 13 by means of bearings; in the exemplary embodiment, two bearings, which are not shown, are provided. The bearings are installed on the volume flow measuring wheel 2 at receptacles 20 provided for them within the hub 7. The volume flow measuring wheel 2 can thereby rotate freely with respect to the inflow grille 26 and independently of the rotor 11 of the motor 4, which drives the impeller 3 of the fan 1. By measuring the speed of the volume flow measuring wheel 2, with the addition of other sensor information, it is possible to infer with a good degree of accuracy the current conveying medium volume flow Qᵥ or another operating-point-dependent variable.

The impeller 3 of the fan 1 is mounted on the rotor 11 of the motor 4 by way of a fixing device 15, which is embodied as a sheet-metal blank, which is encapsulated in the impeller 3 and pressed onto the rotor 11. The measurement and evaluation of the speed n_{Ane} of the volume flow measuring wheel 2 forms an important basis for determining the current conveying medium volume flow Qᵥ or the other current operating-point-dependent variable. If the desire is to determine the current conveying medium volume flow Qᵥ or another current operating-point-dependent variable with a high degree of accuracy, a further piece of sensor information besides the speed n_{Ane} is required since the speed n_{Ane} is also dependent on the (internal) operating state of the fan in addition to the conveying volume flow Qᵥ. Said operating state of the fan may vary, for example, at a constant conveying volume flow Qᵥ in the form of the value of the static pressure increase built up by the fan in the conveying direction. Within the context of the disclosure, an internal, possibly electrical, variable in the motor or in the motor control system is used as such a further piece of sensor information.

The volume flow measuring wheel may generally be mounted on the inflow or outflow side, for example on an inflow grille or in a housing, of a fan. In order to determine the current conveying medium volume flow Qᵥ or another operating-point-dependent variable, another motor-external sensor signal can also be used instead of the speed n_{Ane} of the vane anemometer, which is a motor-external variable. A first example of another motor-external sensor variable is the signal of one more hot-wire anemometers or comparable thermal sensors which react sensitively to the flow velocity. A second example of another motor-external sensor variable is the signal of a differential pressure sensor which measures a differential pressure between two suitable points in the field of the fan, for example the differential nozzle pressure as the difference between the static pressure in the region of the narrowest traversed cross section of the inlet nozzle of a fan and a point further on the inflow side of the inlet nozzle.

The current conveying volume flow Qᵥ or the current value of another operating-point-dependent variable is determined by way of a suitable algorithm from the sensor signal of the motor-external variable and a second sensor signal of a motor-internal electrical variable, such as, for example, a motor current I_{Mot}, a winding voltage U_{Mot} or an electrical power. Said algorithm is advantageously implemented directly in the motor control system, but it may also be implemented in an external evaluation unit. The sensor signals would each of course have to be transmitted to the corresponding locations.

One possible algorithm may look as follows:
1.) determination of the motor-external sensor variable EXT, in the specific example the speed n_{Ane} of the vane anemometer (volume flow measuring wheel) 2
2.) determination of the motor-internal, possibly electrical, variable INT, specifically by way of example the motor winding current I_{Mot}
3.) if required, determination or estimation of the current conveying medium density ρ, advantageously with the aid of further sensor signals (for example temperature and/or humidity)
4.) calculation of the current conveying medium volume flow Qᵥ (or the other operating-point-dependent variable X) with a calibrated approximation function Qᵥ=Qᵥ (EXT,INT,C̅) or Qᵥ=Qᵥ(EXT,INT,C̅,ρ) (or X=X(EXT,INT,C̅) or X=X (EXT,INT,C̅,ρ), where X stands for the corresponding operating-point-dependent variable)

C̅ is an array of calibration coefficients which depends on the type of motor-external sensor variable EXT, the motor-internal sensor variable INT and the operating-point-dependent variable X, but also on the specific fan, the specific sensors and possibly also the specific installation situation. In general, the calibration coefficients C̅ are to be determined by means of a calibration test on a test bench using which the current conveying medium volume flow Qᵥ or the current operating-point-dependent variable X can be measured.

Specifically, a suitable number of basic functions can be formed from the motor-external sensor variable EXT and the motor-internal sensor variable INT, for example monomials, which then form the vector of the basic function B̅. An exemplary monomial-based basic function vector is B̅=(1,EXT,INT,EXT²,EXT·INT,INT², . . . ). Other types of basic function are also conceivable. The current conveying medium volume flow Qᵥ or the current operating-point-dependent variable X can then be approximated using the following scalar product: Qᵥ=C̅·B̅ or Qᵥ= [symbol] C̅·B̅ or X=C̅·B̅ or X=C̅·B̅·f (ρ, T), wherein f (ρ, T) is a determined correction function depending on current conveying medium density ρ and the current conveying medium temperature T.

In a calibration test, with the aid of the test bench, both Qᵥ (or X) and, by means of the sensors, EXT and INT and thus the basic function vector B̅ are known for a sufficient number of measuring points and the array of calibration coefficients C̅ can be determined by way of inversion, for example using a least squares method.

The motor 4 or the evaluation unit advantageously has an interface for transmitting the current conveying volume flow Qᵥ or the current operating-point-dependent variable X to a superordinate system. Furthermore, a signal for a setpoint volume flow or a setpoint value of an operating-point-dependent variable X can advantageously be transmitted to the motor or the evaluation unit such that the motor speed n_{Mot} is controlled automatically in such a way that the conveying medium volume flow Qᵥ or the current operating-point-dependent variable X determined using the sensor signals corresponds as well as possible to the setpoint volume flow or to the setpoint value of X.

For the sake of completeness, it should be mentioned that not all of the components of the fan 1 are illustrated in FIG. 1. In particular, a motor holder which connects the stator 11 of the motor 4 to the nozzle plate 29, for example, is not shown for the sake of clarity. The fan 1 may comprise numerous other components which are not illustrated.

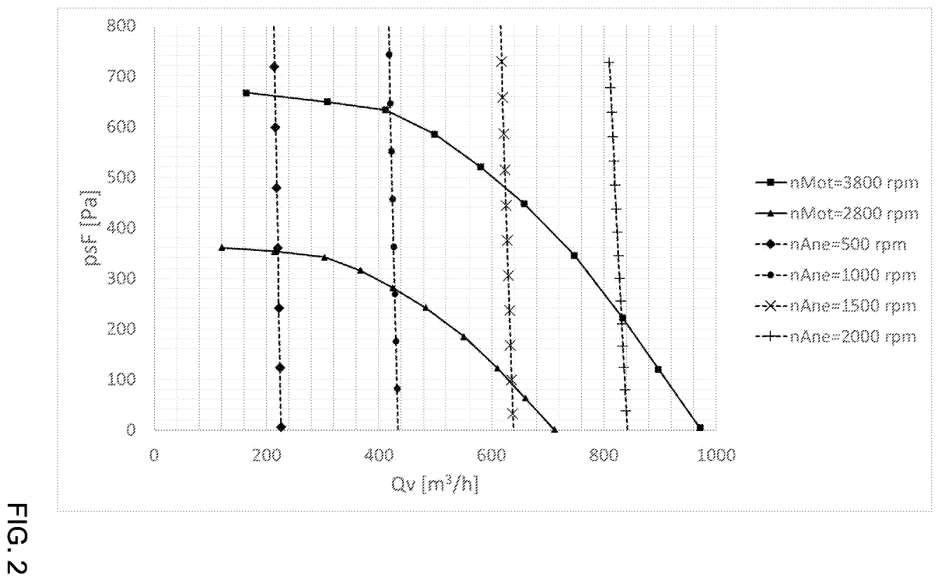

FIG. 2 shows a graph, with the conveying volume flow Qᵥ on the abscissa and the static pressure increase P_{sF} on the ordinate, for any exemplary fan, of two characteristic curves each at a constant motor speed n_{Mot} and four characteristic curves for a respective constant speed n_{Ane} of a vane anemometer mounted close to the fan. It can be seen that the conveying volume flow Qᵥ is not exactly constant at constant n_{Ane}, which means that Qᵥ can only be determined inaccurately without further information, in particular it is too inaccurate for many specific applications, such as controlled home ventilation, for example. This is due, in particular, to the fact that the operating state of the fan impeller (at constant volume flow Qᵥ) influences the anemometer speed n_{Ane} quite significantly since the anemometer wheel is mounted relatively close to the impeller for reasons of compactness. In the graph, it is clear that a possible piece of complementary information for determining the conveying volume flow Qᵥ significantly more accurately is embedded in the motor speed n_{Mot}. For example, the intersection of the characteristic curves for constant motor speed not and constant anemometer speed n_{Ane} could be determined and a more accurate value for the current conveying volume flow Qᵥ could be read out at the intersection of the curves. The statement that the required information is embedded in the combination of both sensor signals is essential. The specific type of algorithm for determining Qᵥ can be carried out in various ways if only the two sensor signals are processed.

However, the determination of the motor speed n_{Mot} is rather complex because a Hall sensor is required, for example. It has been found that a motor-internal, possibly electrical, variable INT, which is significantly easier to detect by way of sensors, can also be used instead of the speed of the motor n_{Mot.}

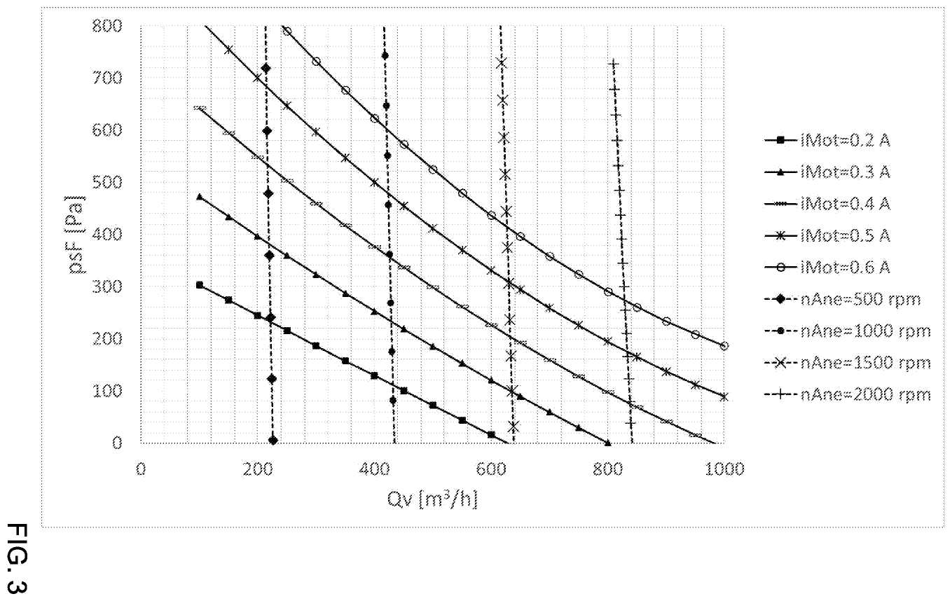

FIG. 3 shows a graph, with the conveying volume flow Qᵥon the abscissa and the static pressure increase p_{sF} on the ordinate, for the exemplary fan from FIG. 2, of five characteristic curves each at a constant motor winding current I_{Mot} and four characteristic curves for a respective constant speed n_{Ane} of a vane anemometer mounted close to the fan. It can be seen that the conveying volume flow Qᵥ is not exactly constant at constant n_{Ane}, Which means that Qᵥ can only be determined inaccurately without further information. This is too inaccurate for many applications. This is due, in particular, to the fact that the operating state of the fan impeller (at constant volume flow Qᵥ) influences the anemometer speed n_{Ane} quite significantly since the anemometer wheel is mounted relatively close to the impeller for reasons of compactness.

In the graph, it is clear that a possible piece of complementary information for determining the conveying volume flow Qᵥ significantly more accurately is also embedded in the motor winding current I_{Mot}, which can be detected by way of sensors with comparatively less effort. For example, the intersection of the characteristic curves for constant motor winding current I_{Mot} and constant anemometer speed n_{Ane} could be determined and a more accurate value for the current conveying volume flow Qᵥ could be read out at the intersection of the curves. The knowledge that the information is embedded in the combination of both sensor signals is essential. The specific type of algorithm for determining Qᵥ can be carried out in various ways if only the two sensor signals are processed, and specifically the motor-external (in this case n_{Ane}) and the motor-internal (in this case I_{Mot}) sensor signals.

It should be mentioned that calibration using measured data on a test bench is required at least for each fan embodiment in order to quantitatively establish the calculation algorithm. For example, for the relevant fan, the characteristic curves for constant motor winding current I_{Mot} and for constant vane anemometer speed n_{Ane} could thus be determined and stored in the motor control system or the evaluation unit. Since other calculation algorithms are also possible, another calibration is then also consequently required. It is essential that a motor-external sensor variable EXT, in this case the speed n_{Ane} of a vane anemometer, and a motor-internal electrical variable INT, in this case the motor winding current I_{Mot}, are processed as sensor variables/input variables in the algorithm to determine the current conveying volume flow Qᵥ or the current value of another operating-point-dependent variable.

It is also conceivable to detect the calibration parameters for a particular application or installation condition in order to achieve an even higher degree of accuracy when determining the current conveying volume flow Qᵥ or the current value of another operating-point-dependent variable in the relevant application.

Within the context of the present disclosure, the motor-external variables used may also be, inter alia, the signal of a hot-wire anemometer or a similar thermal sensor which reacts sensitively to local air speeds or the signal of a differential pressure sensor which measures the static pressure e difference between two specific points in the region of the fan. In both cases, it will typically be determined that the sensor signal also depends on an operating state of the fan impeller as well as the current conveying volume flow Qᵥ, which can be expressed, for example, by the value of the static pressure increase p_{sF}. This dependency on the operating state can be eliminated by adding a sensor signal representing a motor-internal, possibly electrical, variable, which enables a significantly higher degree of accuracy when determining the current conveying volume flow Qᵥ or consequently also the current value of another operating-point-dependent variable.

If a pressure difference or the signal of a hot-wire anemometer is used as the motor-external signal, the current conveying medium density is also required as a further input variable for determining the conveying volume flow Qᵥ. Said conveying medium density can be estimated to be constant or else advantageously can be determined in real time with the aid of further sensor signals (for example relating to the temperature and the moisture content of the conveying medium).

On the other hand, it is possible to infer the conveying medium mass flow using the conveying medium volume flow Qᵥ using the conveying medium density. If a pressure difference or the signal of a hot-wire anemometer is used as the motor-external signal, it is even possible to determine the conveying medium mass flow directly and without knowledge of the conveying medium density.

With respect to further advantageous configurations of the method according to the present disclosure, reference is made to the general part of the description and to the appended claims in order to avoid repetitions.

Finally, reference is expressly made to the fact that the exemplary embodiment of the method according to the present disclosure described above serves purely for discussing the claimed teaching, but this does not restrict the exemplary embodiments.

### LIST OF REFERENCE SIGNS

1 Fan
2 Volume flow measuring wheel, vane anemometer
3 Fan impeller
4 Motor
5 Inflow nozzle
6 Blade of a volume flow measuring wheel
7 Hub of a volume flow measuring wheel
8 Top ring of an impeller
9 Blade of an impeller
10 Hub ring of an impeller
11 Rotor of a motor
12 Stator of a motor
13 Axle for mounting the volume flow measuring wheel
15 Device for fixing the impeller to the motor
20 Receptacle in the volume flow measuring wheel for bearings
26 Inflow grille
29 Nozzle plate
30 Central region of the inflow grille
31 Receiving region for shaft in inflow grille

1. A method for quantitatively determining the current conveying volume flow or another operating-point-dependent variable of a fan which having a motor-driven impeller, comprising:
determining a motor-internal variable and a motor-external variable directly or indirectly calculating or determining by means of an algorithm a conveying volume flow or other operating-point-dependent variable from the motor-internal variable and the motor-external variable.

2. The method as claimed in claim 1, wherein the motor-internal variable is an electric current, in the motor or in the control system thereof.

3. The method as claimed in claim 1, wherein the motor-internal variable is the motor speed.

4. The method as claimed in any one of claim 1, wherein the motor-external variable is measured value or a signal of a sensor which is arranged in the immediate vicinity of the fan or the impeller.

5. The method as claimed in claim 4, wherein the sensor is an anemometer having a volume flow measuring wheel and the motor-external variable is the anemometer speed or the measuring wheel speed.

6. The method as claimed in claim 5, wherein the volume flow measuring wheel is mounted on an inflow-side or on an outflow-side structure; so as to be able to rotate.

7. The method as claimed in claim 4, wherein the sensor is a thermal sensor, which reacts sensitively to a flow velocity.

8. The method as claimed in claim 4, wherein the sensor is a differential pressure sensor which detects a pressure difference between two specific points in a flow field of the fan.

9. The method as claimed in any one of claim 1, wherein the algorithm is implemented in a motor control system or in an external evaluation unit, in each case having a processor and a memory, wherein sensor signals are transmitted to the processor via wire or contactlessly.

10. The method as claimed claim 1, wherein the fan, or the fan motor, has an interface which is used to transmit a determined current conveying volume flow or a determined current operating-state-dependent variable to a superordinate system.

11. The method as claimed in claim 10, wherein a signal for a setpoint volume flow or a setpoint value for an operating-point-dependent variable is transmitted to the motor and/or to the evaluation unit, said signal being used to control a motor speed in such a way that the conveying volume flow or the operating-point-dependent variable determined using a sensor signal or sensor signals corresponds as accurately as possible to the setpoint volume flow or to the setpoint value for the operating-point-dependent variable.

12. A fan for applying a method as claimed in claim 1, configured for controlling the current conveying volume flow or the current operating-point-dependent variable.
